(19) United States
(12) Patent Application Publication
(10) Pub. No.: US 2015/0248763 A1
(43) Pub. Date: Sep. 3, 2015

(54) TURNOFF RECOGNITION APPARATUS

(71) Applicant: DENSO CORPORATION, Kariya-city (JP)

(72) Inventors: SYUNYA KUMANO, Gothenburg (SE); NAOKI KAWASAKI, Kariya-shi (JP); SHUNSUKE SUZUKI, Aichi-ken (JP); TETSUYA TAKAFUJI, Anjo-shi (JP)

(21) Appl. No.: 14/635,484

(22) Filed: Mar. 2, 2015

(30) Foreign Application Priority Data
Mar. 3, 2014 (JP) 2014-040715

(51) Int. Cl. G06T 7/00; G06T 7/40

(52) U.S. Cl. CPC G06T 7/0042; G06T 7/408; G06T 2207/30256

(57) ABSTRACT

An apparatus for determining the presence or absence of a turnoff in a roadway. In the apparatus, a turnoff determiner is configured to, for each of left and right white lane lines selected by a white-lane-line selector, smooth white lane lines previously selected by the white-lane-line selector over time to calculate a smoothed white lane line as a reference line, calculate a white-lane-line deviation that is a maximum one of deviations between the reference line and white-lane-line edge points along the white lane line currently selected by the white-lane-line selector. The turnoff determiner is configured to calculate a degree of belief that a turnoff exists based on the calculated left and right white-lane-line deviations, and based on the calculated left and right white-lane-line deviations, determine the presence or absence of a turnoff in the roadway.

### CROSS-REFERENCE TO RELATED APPLICATION

This application is based on and claims the benefit of priority from earlier Japanese Patent Applications No. 2014-40715 filed Mar. 3, 2014, the descriptions of which are incorporated herein by reference.

### BACKGROUND

1. Technical Field

The present invention relates to techniques for accurately recognizing a turnoff in a roadway.

2. Related Art

A technique, as disclosed in Japanese Patent Application Laid-Open Publication No. 2006-331389, focuses on parallelism with an estimated trajectory of a subject vehicle, and detects a lane of a lower parallelism as a turnoff lane.

Another technique, as disclosed in Japanese Patent Application Laid-Open Publication No. 2005-346383, determines whether or not a pitch angle of the subject vehicle calculated based on a curvature or shape of a detected lane line is greater than a predetermined value, and when it is determined that the pitch angle is greater than the predetermined value, determines that a turnoff exists.

However, there is a problem with the technique disclosed in Japanese Patent Application Laid-Open Publication No.2006-331389 such that, pitching of the subject vehicle due to a road grade may cause a large variation in parallelism or pitch angle even when the subject vehicle is traveling in a non-turnoff lane, which may lead to mis-identification of the non-turnoff lane as a turnoff lane.

There is another problem with the technique as disclosed in Japanese Patent Application Laid-Open Publication No.2006-331389 that determines the presence or absence of a turnoff based on the parallelism with an estimated trajectory of the subject vehicle, such that, when the subject vehicle wanders and eventually faces toward a turnoff lane, the turnoff lane may be mis-identified as a main lane. Such a technique does not have good turnoff recognition accuracy.

There is a problem with the technique as disclosed in Japanese Patent Application Laid-Open Publication No.2005-346383 that determines the presence or absence of a turnoff based on a curvature variation, such that it is not until occurrence of the curvature variation that it is determined that a turnoff exists. Thus, such a technique is less effective in preventing the curvature variation than originally expected and does not have good turnoff recognition accuracy.

In consideration of the foregoing, exemplary embodiments of the present invention are directed to providing techniques for accurately recognizing a turnoff in a roadway.

### SUMMARY

In accordance with an exemplary embodiment of the present invention, there is provided an apparatus for determining the presence or absence of a turnoff in a roadway. In the apparatus, a white-lane-line candidate extractor is configured to apply image processing to an image of surroundings of a subject vehicle acquired by a vehicle-mounted camera to extract white-lane-line candidates in the roadway. The subject vehicle is a vehicle equipped with the apparatus in the vehicle. A degree-of-belief calculator is configured to calculate, for each of the white-lane-line candidates extracted by the white-lane-line candidate extractor, a degree of belief (likelihood) that the white-lane-line candidate is likely to a true white lane line. A white-lane-line selector is configured to, based on the degrees of belief calculated by the degree-of-belief calculator, select one of the white-lane-line candidates as a white lane line on each of left and right hand sides of the subject vehicle. A turnoff determiner is configured to, for each of the left and right white lane lines selected by the white-lane-line selector, smooth the white lane lines previously selected by the white-lane-line selector over time to calculate a smoothed white lane line as a reference line, calculate a white-lane-line deviation that is a maximum one of deviations between the reference line and white-lane-line edge points along the white lane line currently selected by the white-lane-line selector. The turnoff determiner is further configured to calculate a degree of belief (likelihood) that a turnoff exists based on the calculated left and right white-lane-line deviations, and based on the calculated left and right white-lane-line deviations, determine the presence or absence of a turnoff in the roadway.

With this configuration, pitching of the subject vehicle and traveling along a tight curve and others may cause left and right deviations between the reference line and the white-lane-line edge points, where the left and right deviations are substantially equal to each other. Therefore, use of the left and right deviations as features allows the presence or absence of a turnoff to be determined at an earlier timing while preventing a non-turnoff from being misidentified as a turnoff. This may lead to good turnoff-recognition accuracy.

### BRIEF DESCRIPTION OF THE DRAWINGS

FIG. 1 is a block diagram of a turnoff recognition apparatus in accordance with one embodiment of the present invention;

FIG. 2 is a schematic of positioning a vehicle-mounted camera within a vehicle;

FIG. 3 is a functional block diagram of an image processor of the turnoff recognition apparatus;

FIG. 4 is a flowchart of a turnoff recognition process;

FIG. 5 is a turnoff likelihood map illustrating a graph of likelihood vs. white-lane-line variation;

FIG. 6A is a schematic of performing a turnoff recognition process;

FIG. 6B is a schematic of determining that no turnoff exists; and

FIG. 6C is a schematic of determining that a turnoff exists.

### DETAILED DESCRIPTION OF THE PREFERRED EMBODIMENTS

The description herein makes reference to the accompanying drawings wherein like reference numerals refer to like parts throughout the several views.

### 1. Turnoff Recognition Apparatus

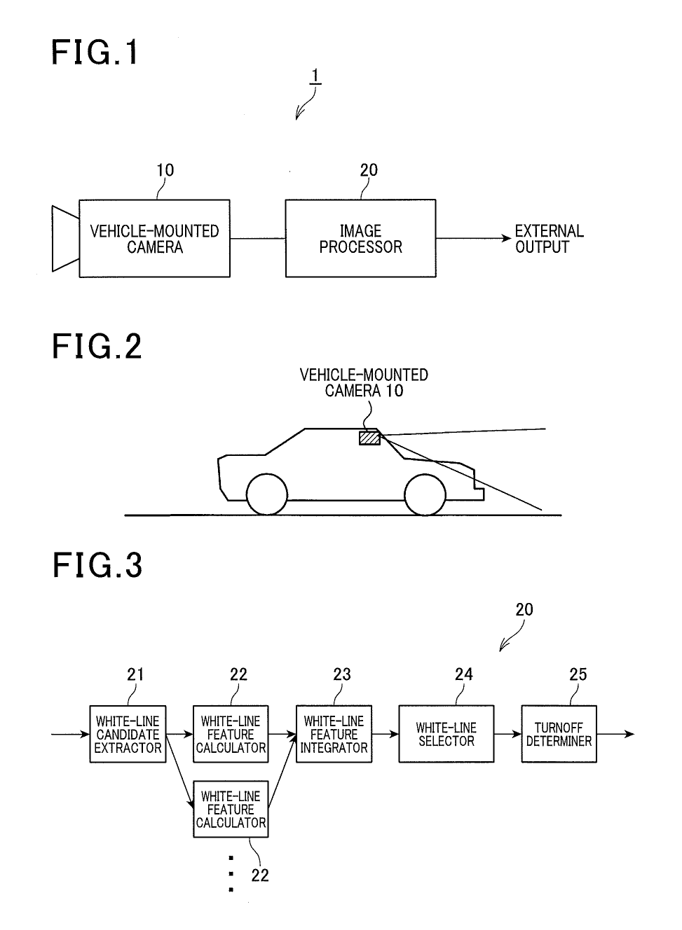

A turnoff recognition apparatus 1, as shown in FIG. 1, includes a vehicle-mounted camera 10 configured to capture images of surroundings of a subject vehicle (that is a vehicle equipped with the apparatus), and an image processor 20 configured to process the images captured by the vehicle-mounted camera 10.

### 1.1. Vehicle-Mounted Camera

The vehicle-mounted camera 10 includes a charge-coupled device (CCD) camera. As shown in FIG. 2, the vehicle-mounted camera 10 is disposed in the center front of the vehicle to sequentially capture images ahead of the subject vehicle.

### 1.2. Image Processor

The image processor (IP) 20 may be a well-known microcomputer including Central Processing Unit (CPU), Read Only Memory (ROM), Random Access Memory (RAM), Electrically Erasable Programmable Read-Only Memory (EEPROM), Digital Signal Processors (DSPs) and others. As shown in FIG. 3, the image processor 20 includes various DSPs which respectively function as a white-lane-line candidate extractor 21, a set of white-lane-line feature calculators 22, a white-lane-line feature integrator 23, a white-lane-line selector 24, and a turnoff determiner 25. Alternatively, these functional blocks 21-25 may be implemented by the CPU executing computer programs stored in the ROM or the like.

The white-lane-line candidate extractor 21 is configured to process an image acquired by the vehicle-mounted camera 10 to extract a likely white lane line (hereinafter also referred to as a white-lane-line candidate) in a roadway. More specifically, the white-lane-line candidate in the roadway is extracted from the image acquired by the vehicle-mounted camera 10 via well-known image processing, such as pattern matching, the number of votes in the Hough-transform for straight-line extraction (a solid- or broken-line determination). It should be noted that a plurality of white-lane-line candidates may be extracted in one frame of image.

The set of white-lane-line feature calculators 22 are configured to calculate a plurality of degrees of belief in white-lane-line likeness for each of the white-lane-line candidates extracted by the white-lane-line candidate extractor 21. Each of the plurality of degrees of belief in white-lane-line likeness takes a value (likelihood) within a range of 0.01-1. The plurality of degrees of belief in white-lane-line likeness are respectively associated with the following processes of (1) determining a line-type (compound-line) pattern, (2) determining solidness (votes), (3) determining straightness, (4) determining contrast intensity, (5) determining contrast conspicuity, (6) determining white-lane-line plainness, (7) determining a distance from a crosswalk, (8) determining luminance relative to the roadway surface, and (9) determining a distance from an object.

The white-lane-line feature integrator 23 is configured to calculate and output a product of the degrees of belief in white-lane-line likeness determined in the respective processes (1)-(9) in the Bayesian inference scheme as a white-lane-line likelihood (i.e., a likelihood indicative of how the white-lane-line candidate is likely). The white-lane-line feature calculators 22 and the white-lane-line feature integrator 23 form a degree-of-belief calculator.

The white-lane-line selector 24 is configured to select, on each of the left and right hand sides of the subject vehicle, a white-lane-line candidate having a maximum likelihood among the likelihoods outputted from the white-lane-line feature integrator 23 as a white lane line. In addition, the left and right white lane lines to be selected have the following features that define left and right white lane lines for a traveling lane of the subject vehicle: (i) the white lane lines are inner-most solid lines relative to the subject vehicle, (ii) neither left nor right white lane line is an outer lane line when it is determined that a turnoff exits, and (iii) the left and right white lane lines are likely left and right lane lines, and others. The white-lane-line feature integrator 23 outputs, for each white-lane-line candidate, a likelihood that is an integration of degrees of belief in white-lane-line likeness for the white-lane-line candidate. The white-lane-line selector 24 selects, on each of the left and right hand sides of the subject vehicle, a white-lane-line candidate having a maximum likelihood, based on the above features.

The turnoff determiner 25 is a DSP configured to perform a turnoff recognition process (described later) to calculate a degree of belief in the presence of a turnoff (or a degree of belief that a turnoff exists) from features of the white lane line selected by the white-lane-line selector 24, and based on the degree of belief in the presence of a turnoff, determine the presence or absence of the turnoff. The turnoff determiner 25 is configured to, on each of the left and right hand sides of the subject vehicle, smooth the white lane lines selected by the white-lane-line selector 24 over time (or over the past several cycles) to calculate a smoothed white lane line as a reference line, and calculate deviations between the reference line and white-lane-line edge points along the white lane line selected by the white-lane-line selector 24 in the current cycle, and based on the deviations, calculate a degree of belief that a turnoff exists.

### 2. Turnoff Recognition Process

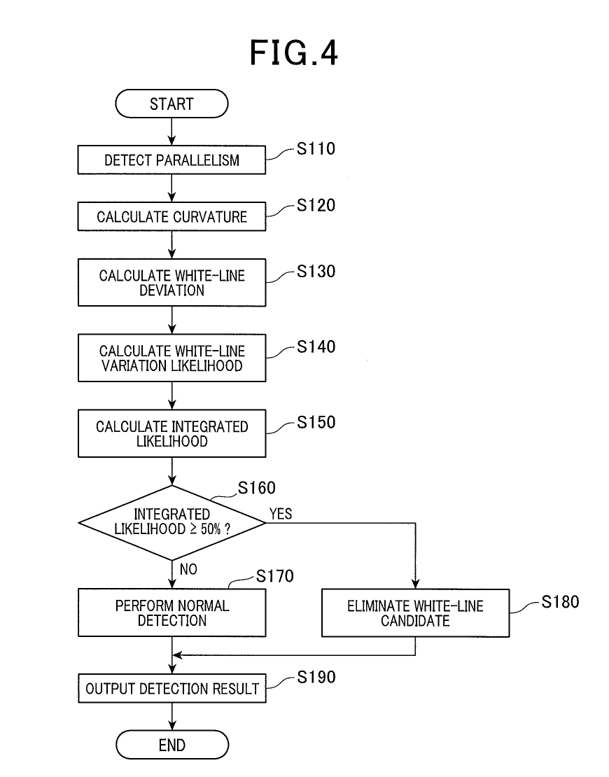

The turnoff recognition process to be performed in the image processor 20 will now be explained with reference to the flowchart of FIG. 4.

The turnoff recognition process is performed repeatedly every predetermined time interval during travelling of the subject vehicle. First, in step S110, a parallelism is calculated. More specifically, the turnoff determiner 25 calculates a parallelism between the left and right white lane lines selected by the white-lane-line selector 24. Thereafter, the process proceeds to step S120.

In step S120, a curvature is calculated. More specifically, the turnoff determiner 25 calculates, for each of the left and right white lane lines selected by the white-lane-line selector 24, a curvature of the white lane line. Thereafter, the process proceeds to step S130.

In step S130, for each of the left and right white lane lines selected by the white-lane-line selector 24, the turnoff determiner 25 calculates a white-lane-line deviation that is a maximum one of deviations between the reference line and white-lane-line edge points along the white lane line selected by the white-lane-line selector 24 in the current cycle. Thereafter, the process proceeds to step S140. The white-lane-line deviation is hereinafter referred to as a white-lane-line variation.

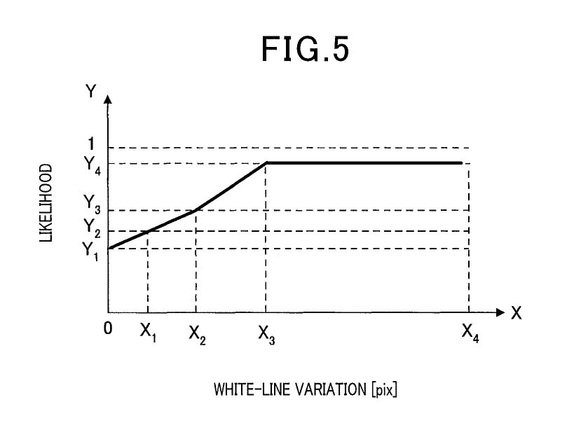

In step S140, a white-lane-line variation likelihood is calculated. More specifically, for each of the left and right white lane lines selected by the white-lane-line selector 24, the turnoff determiner 25 calculates a likelihood of the white-lane-line variation. More specifically, FIG. 5 shows a graph of likelihood vs. white-lane-line variation (the graph being hereinafter referred to as a turnoff likelihood map). The turnoff determiner 25 calculates a likelihood of the white-lane-line deviation calculated in step S130 for each of the left and right white lane lines selected by the white-lane-line selector 24 with reference to the graph of FIG. 5. Thereafter, the process proceeds to step S150.

In step S150, an integrated likelihood is calculated. More specifically, the turnoff determiner 25 calculates an integrated likelihood that is a product of the white-lane-line variation likelihood and other likelihoods (such an integrated likelihood being hereinafter referred to as a turnoff integrated likelihood). Without any other likelihoods to be integrated with the white-lane-line variation, the integrated likelihood is just the white-lane-line variation likelihood. Thereafter, the process proceeds to step S160. A technique for calculating such an integrated likelihood is described in U.S. Pat. No. 8,744,194, which is also owned by the present assignees and hereby incorporated by reference in its entirety.

In step S160, it is determined whether or not the turnoff integrated likelihood (in percent figures) is equal to or greater than a predetermined value. More specifically, the turnoff determiner 25 determines whether or not the turnoff integrated likelihood calculated in step S150 is equal to or greater than 50% as the predetermined value. If it is determined in step S160 that the turnoff integrated likelihood is equal to or greater than 50%, then the process proceeds to step S180. If it is determined in step S160 that the turnoff integrated likelihood is less than 50%, then the process proceeds to step S170.

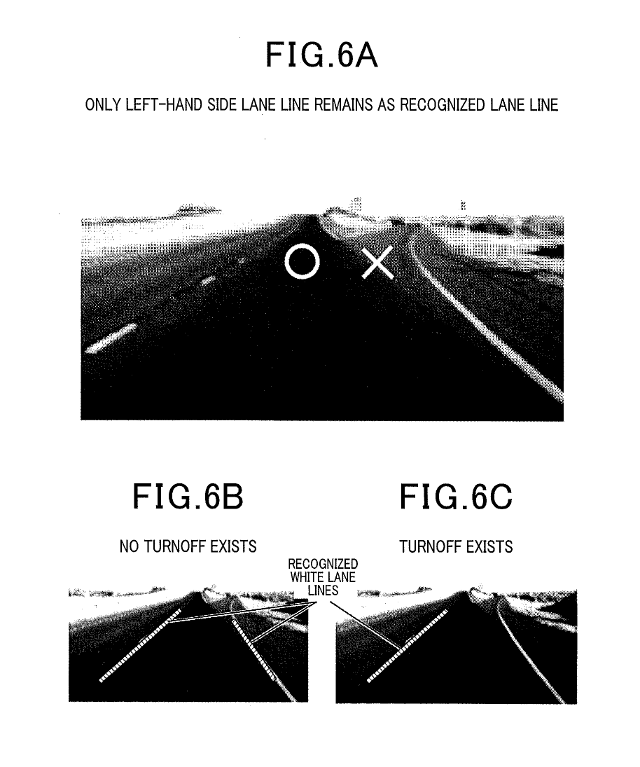

In step S170, normal detection is performed. More specifically, upon determination in step S160 that the turnoff integrated likelihood of the subject white-lane-line candidate (i.e., the white-lane-line candidate being processed) is less than 50%, the turnoff determiner 25 detects the subject white-lane-line candidate as a white lane line (see the lane line marked by the circle in FIG. 6A). For example, as shown in FIG. 6B, the right-hand side lane line is detected as a white lane line. Therefore, the left- and right-hand side lane lines are both recognized as left and right white lane lines along which driving of the subject vehicle is controlled, which leads to determination that no turnoff exists. Thereafter, the process proceeds to step S170.

In step S180, the turnoff determiner 25 eliminates the subject white-lane-line candidate. More specifically, upon determination in step S160 that the turnoff integrated likelihood of the subject white-lane-line candidate is equal to or greater than 50%, the turnoff determiner 25 eliminates or excludes the subject white-lane-line candidate (see the lane line marked by the cross in FIG. 6A). The turnoff determiner 25 determines that a turnoff exists. For example, as shown in FIG. 6C, the right-hand side lane line is eliminated. Therefore, only the left-hand side lane line remains as a recognized white lane line along which driving of the subject vehicle is controlled, which leads to the determination that a turnoff exists. Thereafter, the process proceeds to step S190.

In step S190, the turnoff determiner 25 outputs a detection result. More specifically, if the process proceeds from step S170 to step S190, then the turnoff determiner 25 outputs a detection result that the subject white-lane-line candidate has been detected as a white lane line. If the process proceeds from step S180 to step S190, then the turnoff determiner 25 eliminates the subject white-lane-line candidate and outputs a detection result that a turnoff exists. Thereafter, the process ends. The turnoff determiner 25 includes a section (as a determination output) for outputting the detection result.

### 3. Advantages

In the turnoff recognition apparatus 1 of the present embodiment, the turnoff determiner 25 is a DSP configured to calculate a degree of belief in the presence of a turnoff (or a degree of belief that a turnoff exists) from features of the white lane line selected by the white-lane-line selector 24, and based on the degree of belief in the presence of a turnoff, determine the presence or absence of the turnoff. The turnoff determiner 25 is configured to, on each of the left and right hand sides of the subject vehicle, smooth the white lane lines selected by the white-lane-line selector 24 over time (or over the past several cycles of the turnoff recognition process) to calculate a smoothed white lane line as a reference line, and calculate deviations between the reference line and white-lane-line edge points along the white lane line selected by the white-lane-line selector 24 in the current cycle, and based on the deviations, calculate a degree of belief that a turnoff exists.

Pitching of the subject vehicle and traveling along a tight curve and others may cause left and right deviations between the reference line and the white-lane-line edge points along the left-or right white lane line. Therefore, use of the white-lane-line deviation as a white-lane-line feature allows the presence or absence of a turnoff to be determined at an earlier timing while preventing a non-turnoff from being mis-identified as a turnoff. This may lead to good turnoff-recognition accuracy.

What is claimed is:

1. An apparatus for determining the presence or absence of a turnoff in a roadway, the apparatus comprising:
a white-lane-line candidate extractor configured to apply image processing to an image of surroundings of a subject vehicle acquired by a vehicle-mounted camera to extract white-lane-line candidates in the roadway, the subject vehicle being a vehicle equipped with the apparatus;
a degree-of-belief calculator configured to calculate, for each of the white-lane-line candidates extracted by the white-lane-line candidate extractor, a degree of belief that the white-lane-line candidate is likely to a true white lane line;
a white-lane-line selector configured to, based on the degrees of belief calculated by the degree-of-belief calculator, select one of the white-lane-line candidates as a white lane line on each of left and right hand sides of the subject vehicle; and
a turnoff determiner configured to, for each of the left and right white lane lines selected by the white-lane-line selector, smooth the white lane lines previously selected by the white-lane-line selector over time to calculate a smoothed white lane line as a reference line, calculate a white-lane-line deviation that is a maximum one of deviations between the reference line and white-lane-line edge points along the white lane line currently selected by the white-lane-line selector, the turnoff determiner being configured to calculate a degree of belief that a turnoff exists based on the calculated left and right white-lane-line deviations, and based on the calculated left and right white-lane-line deviations, determine the presence or absence of a turnoff in the roadway.

2. The apparatus of claim 1, wherein the turnoff determiner is configured to, when the degree of belief that a turnoff exists calculated by the turnoff determiner is equal to or greater than a predetermined value, determine that a turnoff exists in the roadway, and when the degree of belief that a turnoff exists calculated by the turnoff determiner is less than the predetermined value, determine that no turnoff exists in the roadway.

3. The apparatus of claim 1, wherein the turnoff determiner further comprises a determination output configured to output the determination result of the turnoff determiner.

4. The apparatus of claim 2, wherein the degree of belief that a turnoff exists calculated by the turnoff determiner takes a value in percent figures, and the predetermined value is 50%.
